(19) United States
(12) Patent Application Publication
(10) Pub. No.: US 2023/0199259 A1
(43) Pub. Date: Jun. 22, 2023

(54) COMPUTER-READABLE STORAGE MEDIUM, TERMINAL, AND METHOD

(71) Applicant: 17LIVE Japan Inc., Tokyo (JP)

(72) Inventors: Liang-Tse CHIANG, Taipei City (TW); Jhu-Kai SONG, Taipei City (TW)

(21) Appl. No.: 17/875,215

(22) Filed: Jul. 27, 2022

(30) Foreign Application Priority Data
Dec. 17, 2021 (JP) 2021-205415

(51) Int. Cl. H04N 21/4784; H04N 21/472; H04N 21/2187; H04N 21/2743

(52) U.S. Cl. CPC H04N 21/4784; H04N 21/472; H04N 21/2187; H04N 21/2743

(57) ABSTRACT

A computer-readable tangible non-transitory storage medium storing a program causing a terminal to: display a first user interface object representing a gift of a first type on a display while video data related to a live-stream is reproduced; process data for realizing an effect for the gift represented by the first user interface object upon acceptance of selection of the first user interface object by a user of the terminal, the data being stored in a holding unit of the terminal; display a second user interface object representing a gift of a second type on the display while the video data is reproduced; and start download of data for realizing an effect for the gift represented by the second user interface object upon acceptance of selection of the second user interface object by the user.

### CROSS-REFERENCE TO RELATED APPLICATIONS

This application is based on and claims the benefit of priority from Japanese Patent Application Serial No. 2021-205415 (filed on Dec. 17, 2021), the contents of which are hereby incorporated by reference in its entirety.

### TECHNICAL FIELD

The present disclosure relates to a terminal, a method, and a non-transitory computer-readable storage medium storing a program.

### BACKGROUND

With the development of IT technology, the way information is exchanged has changed. In the Showa period (1926-1989), one-way information communication via newspapers and television was the main stream. In the Heisei period (1990-2019), with the widespread availability of cell phones and personal computers, and the significant improvement in Internet communication speed, instantaneous interactive communication services such as chat services emerged, and on-demand video distribution services also become popular as storage costs were reduced. And nowadays, with the sophistication of smartphones and further improvements in network speed as typified by 5G, services that enable real-time communication through video, especially live-stream services, are gaining recognition. The number of users of live-stream services is expanding, especially among young people, as such services allow people to share fun moments even when they are in the separate locations from each other.

Effects of gifts such as coins may help live-streamers engage more with viewers. If a wide variety of gift effects is offered and each gift can be elaborately designed, those gifts may make live-streams more exciting.

Japanese Patent Application Publication No. 2020-017870 describes a technique to make a live-stream more exciting by showing a Nagesen (tipping) effect with which a donation from a viewer to a live-streamer is shown on the live-stream screen.

Live-streaming requires immediate interactions between the distributor and the viewers. Therefore, usually all the data needed for gift effects is downloaded to a user’s terminal in advance so that they can be used immediately upon the user’s instruction.

However, the size of the data for realizing gift effects increases as the effects become more elaborate. Moreover, the more types of such gifts, the larger the data capacity required to store such gift data. Data of such a live-streaming application occupies a large portion of the storage capacity of the terminal in which the live-streaming application is installed, which may cause slow operation, limiting installation of other applications. This may lead to poor user experience.

### SUMMARY

One object of the present disclosure is to provide a technique that enables the use of elaborate gifts in live-streaming while reducing the resulting increase in data volume.

One aspect of the disclosure relates to a non-transitory computer-readable storage medium storing a program. The program causes a terminal to: display a first user interface object representing a gift of a first type on a display while video data related to a live-stream is reproduced; process data for realizing an effect for the gift represented by the first user interface object upon acceptance of selection of the first user interface object by a user of the terminal, the data being stored in a holding unit of the terminal; display a second user interface object representing a gift of a second type on the display while the video data is reproduced; and start download of data for realizing an effect for the gift represented by the second user interface object upon acceptance of selection of the second user interface object by the user.

It should be noted that the components described throughout this disclosure may be interchanged or combined. The components, features, and expressions described above may be replaced by devices, methods, systems, computer programs, recording media containing computer programs, etc. Any such modifications are intended to be included within the spirit and scope of the present disclosure.

### Advantageous Effects

According to the aspect of the present disclosure, it is possible to reduce the data volume increase in live-streaming while enabling the use of elaborate gifts.

### BRIEF DESCRIPTION OF THE DRAWINGS

FIG. 1 schematically illustrates a configuration of a live-streaming system in one embodiment of the disclosure.

FIG. 2 schematically illustrates an example of live-streaming implemented by the live-streaming system of FIG. 1.

FIG. 3 is a block diagram showing functions and configuration of a user terminal of FIG. 1.

FIG. 4 is a data structure diagram showing an example of a terminal-side gift holding unit of FIG. 3.

FIG. 5 is a data structure diagram showing an example of a download queue holding unit of FIG. 3.

FIG. 6 is a block diagram showing functions and configuration of a server of FIG. 1.

FIG. 7 is a data structure diagram showing an example of a gift download list of FIG. 6.

FIG. 8 is a data structure diagram of an example of a stream DB in FIG. 6.

FIG. 9 is a data structure diagram showing an example of a user DB in FIG. 6.

FIG. 10 is a data structure diagram showing an example of a gift DB in FIG. 6.

FIG. 11 is a flowchart showing steps of an application activation process on a user terminal.

FIG. 12 is a flowchart showing steps of a download process on the user terminal.

FIG. 13 is a flowchart showing steps of a gift usage process on the user terminal.

FIG. 14 is a representative screen image of a live streaming selection screen displayed on a display of a viewer’s user terminal.

FIG. 15 is a representative screen image of a live streaming room screen displayed on the display of the viewer’s user terminal.

FIG. 16 is a representative screen image of a live streaming room screen displayed on the display of the viewer’s user terminal.

FIG. 17 is a representative screen image of a live streaming room screen displayed on the display of the viewer’s user terminal.

FIG. 18 is a representative screen image of a live streaming room screen displayed on the display of the viewer’s user terminal.

FIG. 19 is a representative screen image of a live streaming room screen displayed on the display of the viewer’s user terminal.

FIG. 20 is a block diagram showing an example of a hardware configuration of an information processing device according to the embodiment.

### DESCRIPTION OF EXAMPLE EMBODIMENTS

Like elements, components, processes, and signals throughout the Figures are labeled with same or similar designations and numbering, and the description for the like elements will not be hereunder repeated. For purposes of clarity and brevity, some of the components that are less related and thus not described are not shown in Figures.

Instead of downloading data that realize effects of all gifts (hereinafter referred to as “effect data”) to a user terminal, a live-streaming system related to an embodiment divides gifts into two types: a preloaded type gifts of which effect data is downloaded in advance, and a load-required type gifts of which effect data is downloaded when used. When a viewer wishes to use a gift that requires loading, the viewer taps the icon of the gift (hereinafter referred to as “gift icon”) to start downloading the effect data of the gift. Once the download is complete, the viewer can use the gift. Gift that are used infrequently may be configured as the load-required type gifts.

This can suppress the increase in the time required for preloading the gifts even if the size of each gift’s effect data increases, and can also suppress the increase in the total size of the preloaded effect data. In this way, the increase in communication performance and capacity required for user terminals can be suppressed while allowing richer animation and voice expression using larger effect data. In addition, since the preloaded type gifts do not require downloading when they are used, the immediacy of interaction between a distributor and viewers can be ensured for the preloaded type gifts.

As discussed above, the embodiment can reduce the download size of gifts by optimizing the gift download process, thereby achieving both a good user experience and a low load on the terminal.

### Configuration of Live-Streaming System

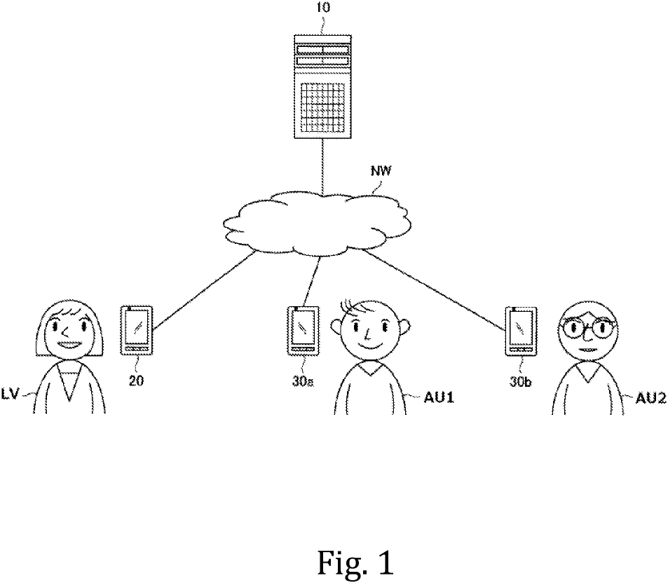

FIG. 1 schematically illustrates a configuration of a live-streaming system 1 according one embodiment of the disclosure. The live-streaming system 1 provides an interactive live-stream service that allows a distributor LV (also referred to as a liver or streamer) and a viewer AU (also referred to as audience) (AU1, AU2 ...) to communicate in real time. As shown in FIG. 1, the live-streaming system 1 includes a server 10, a user terminal 20 on the distributor side, and user terminals 30 (30a, 30b,) on the audience side. The distributor and viewers may be collectively referred to as users. The server 10 may be one or more information processing devices connected to a network NW. The user terminals 20 and 30 may be, for example, mobile terminal devices such as smartphones, tablets, laptop PCs, recorders, portable gaming devices, and wearable devices, or may be stationary devices such as desktop PCs. The server 10, the user terminal 20, and the user terminal 30 are interconnected so as to be able to communicate with each other over the various wired or wireless network NW.

The live-streaming system 1 involves the distributor LV, the viewers AU, and an administrator (not shown) who manages the server 10. The distributor LV is a person who broadcasts contents in real time by recording the contents with his/her user terminal 20 and uploading them directly to the server 1. Examples of the contents may include the distributor’s own songs, talks, performances, fortune-telling, gameplays, and any other contents. The administrator provides a platform for live-streaming contents on the server 10, and also mediates or manages real-time interactions between the distributor LV and the viewers AU. The viewer AU accesses the platform at his/her user terminal 30 to select and view a desired content. During live-streaming of the selected content, the viewer AU performs operations to comment and cheer via the user terminal 30, the distributor LV who is delivering the content responds to such a comment and cheer, and such response is transmitted to the viewer AU via video and/or audio, thereby establishing an interactive communication.

The term “live-streaming” may mean a mode of data transmission that allows a content recorded at the user terminal 20 of the distributor LV to be played and viewed at the user terminals 30 of the viewers AU substantially in real time, or it may mean a live broadcast realized by such a mode of transmission. The live-streaming may be achieved using existing live streaming technologies such as HTTP Live Streaming, Common Media Application Format, Web Real-Time Communications, Real-Time Messaging Protocol and MPEG DASH. Live-streaming includes a transmission mode in which the viewers AU can view a content with a specified delay simultaneously with the recording of the content by the distributor LV As for the length of the delay, it may be acceptable for a delay even with which interaction between the distributor LV and the viewers AU can be established. Note that the live-streaming is distinguished from so-called on-demand type transmission, in which the entire recorded data of the content is once stored on the server and the data is then provided to a user at any subsequent time upon request from the user.

The term “video data” herein refers to data that includes image data (also referred to as moving image data) generated using an image capturing function of the user terminals 20 and 30, and audio data generated using an audio input function of the user terminals 20 and 30. Video data is reproduced in the user terminals 20 and 30, so that the users can view contents.

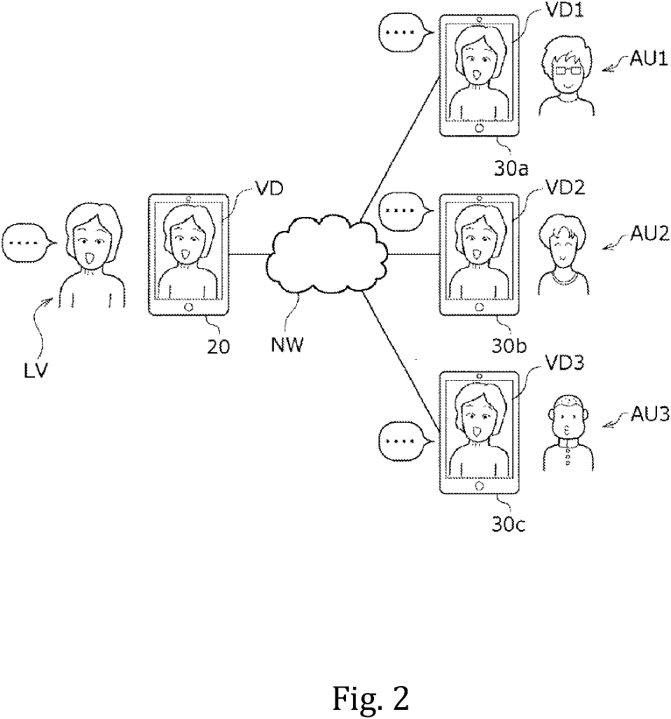

FIG. 2 schematically illustrates an example of live-streaming implemented by the live-streaming system of FIG. 1. In the example in FIG. 2, the distributor LV is live-streaming his/her talk. The user terminal 20 of the distributor LV generates video data by recording images and sounds of the distributor LV talking, and the generated data is transmitted to the server 10 (not shown in FIG. 2) over the network NW. At the same time, the user terminal 20 displays a recorded video image VD of the distributor LV on the display of the user terminal 20 to allow the distributor LV to check the live stream currently performed.

The user terminals 30a, 30b, and 30c of the viewers AU1, AU2, and AU3, respectively, who have requested the platform to view the live-stream of the distributor LV, receive video data related to the live-stream (may also be herein referred to as “live-streaming video data”) over the network NW and reproduce the received video data to display video images VD1, VD2, and VD3 on the displays and output audio through the speakers. The video images VD1, VD2, and VD3 displayed at the user terminals 30a, 30b, and 30c, respectively, are substantially the same as the video image VD captured by the user terminal 20 of the distributor LV, and the audio outputted at the user terminals 30a, 30b, and 30c is substantially the same as the audio recorded by the user terminal 20 of the distributor LV

Recording of the images and sounds at the user terminal 20 of the distributor LV and reproduction of the video data at the user terminals 30a, 30b, 30c of the viewers AU1, AU2, AU3 are performed substantially simultaneously. Once the viewer AU1 types a comment about the talk of the distributor LV on the user terminal 30a, the server 10 displays the comment on the user terminal 20 of the distributor LV in real time and also displays the comment on the user terminals 30a, 30b, and 30c of the viewers AU1, AU2, and AU3, respectively. When the distributor LV read the comment and develops his/her talk to cover and respond the comment, the video and sound of the talk are displayed on the user terminals 30a, 30b, 30c of the viewers AU1, AU2, AU3 respectively. This interactive action is recognized as establishment of a conversation between the distributor LV and the viewer AU1. In this way, the live-streaming system 1 realizes the live-streaming that enables the interactive communication, not one-way communication.

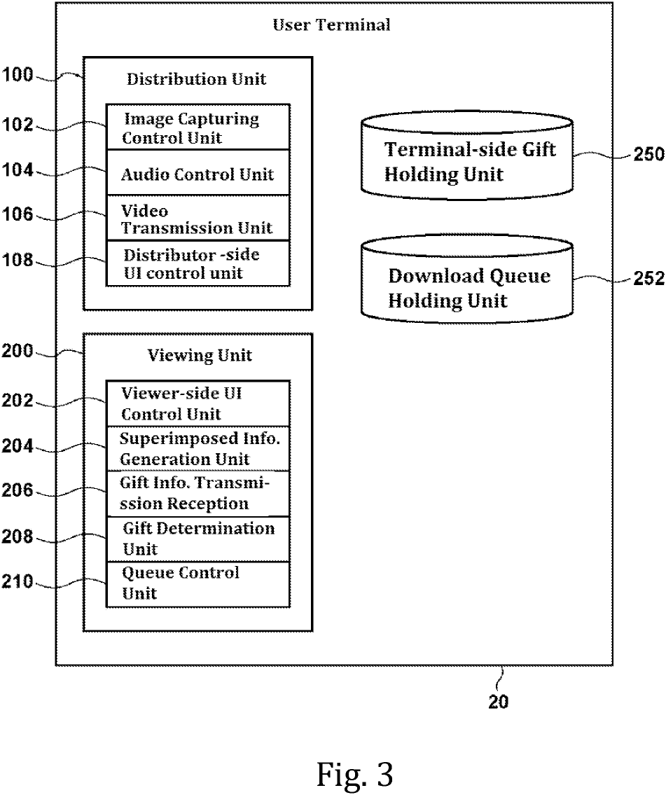

FIG. 3 is a block diagram showing functions and configuration of the user terminal 20 of FIG. 1. The user terminal 30 has the same functions and configuration as the user terminal 20. Each block in FIG. 3 and the subsequent block diagrams may be realized by elements such as a computer CPU or a mechanical device in terms of hardware, and can be realized by a computer program or the like in terms of software. Functional blocks realized by cooperative operation between these elements. Therefore, it is understood by those skilled in the art that these functional blocks can be realized in various forms by combining hardware and software.

The distributor LV and the viewers AU download and install a live-streaming application program (hereinafter referred to as a live-streaming application) according to the embodiment to the user terminals 20 and 30 from a download site over the network NW. Alternatively, the live-streaming application may be pre-installed on the user terminals 20 and 30. When the live-streaming application is executed on the user terminals 20 and 30, the user terminals 20 and 30 communicate with the server 10 over the network NW to implement various functions. Hereinafter, the functions implemented by the user terminals 20 and 30 (processors such as CPUs) in which the live-streaming application is run will be described as functions of the user terminals 20 and 30. These functions are realized in practice by the live-streaming application on the user terminals 20 and 30. In any other embodiments, these functions may be realized by a computer program that is written in a programming language such as HTML (HyperText Markup Language), transmitted from the server 10 to web browsers of the user terminals 20 and 30 over the network NW, and executed by the web browsers.

User terminal 20 has a delivery unit 100 that generates video data recording the user’s image and sound and provides it to server 10, a viewing unit 200 that acquires and plays the video data from server 10, a terminal-side gift holding unit 250 that holds information on gifts at user terminal 20, and a download queue holding unit 252 that holds a queue for downloading gifts. The user activates the distribution unit 100 when the user performs live-streaming, and activates the viewing unit 200 when the user views a video. The user terminal in which the distribution unit 100 is activated is the distributor’s terminal, i.e., the user terminal that generates the video data, and the user terminal in which the viewing unit 200 is activated is the viewer’s terminal, i.e., the user terminal is which the video data is reproduced and played.

The distribution unit 100 includes an image capturing control unit 102, an audio control unit 104, a video transmission unit 106, and a distributor-side UI control unit 108. The image capturing control unit 102 is connected to a camera (not shown in FIG. 3) and controls image capturing performed by the camera. The image capturing control unit 102 obtains image data from the camera. The audio control unit 104 is connected to a microphone (not shown in FIG. 3) and controls audio input from the microphone. The audio control unit 104 obtains audio data through the microphone. The video transmission unit 106 transmits video data including the image data obtained by the image capturing control unit 102 and the audio data obtained by the audio control unit 104 to the server 10 over the network NW. The video data is transmitted by the video transmission unit 106 in real time. That is, the generation of the video data by the image capturing control unit 102 and the audio control unit 104, and the transmission of the generated video data by the video transmission unit 106 are performed substantially at the same time.

The distributor-side UI control unit 108 controls an UI for the distributor. The distributor-side UI control unit 108 is connected to a display (not shown in FIG. 3), and displays a video on the display by reproducing the video data that is to be transmitted by the video transmission unit 106. The distributor-side UI control unit 108 displays an operation object or an instruction-accepting object on the display, and accepts inputs from the distributor who taps on the object.

The viewing unit 200 includes a viewer-side UI control unit 202, a superimposed information generation unit 204, an input information transmission-reception unit 206, a gift determination unit 208, and a queue control unit 210. The viewer-side UI control unit 202 controls the UI for the viewers. The viewing-side UI control unit 202 is connected to a display and speaker (not shown in FIG. 3), and reproduces the received video data to display video images on the display and output audio through the speaker. The state where the image is outputted to the display and the audio is outputted from the speaker can be referred to as “the video data is played”. The viewer-side UI control unit 202 is also connected to input means (not shown in FIG. 3) such as touch panels, keyboards, and displays, and obtains user input via these input means. The superimposed information generation unit 204 superimposes a predetermined frame image on an image generated from the video data from the server 10. The frame image includes various user interface objects (hereinafter simply referred to as “objects”) for accepting inputs from the user, comments entered by the viewers, and information obtained from the server 10.

The viewer-side UI control unit 202 displays gift icons in conjunction with the superimposed information generation unit 204 during reproduction of the live-stream video data. The gift icons include a gift icon representing the preloaded type gift and a gift icon representing the load-required type gift.

The gift information transmission-reception unit 206 transmits and receives information related to gifts to and from the server 10. The gift determination unit 208 determines the type of a gift. The queue control unit 210 controls the download queue holding unit 252.

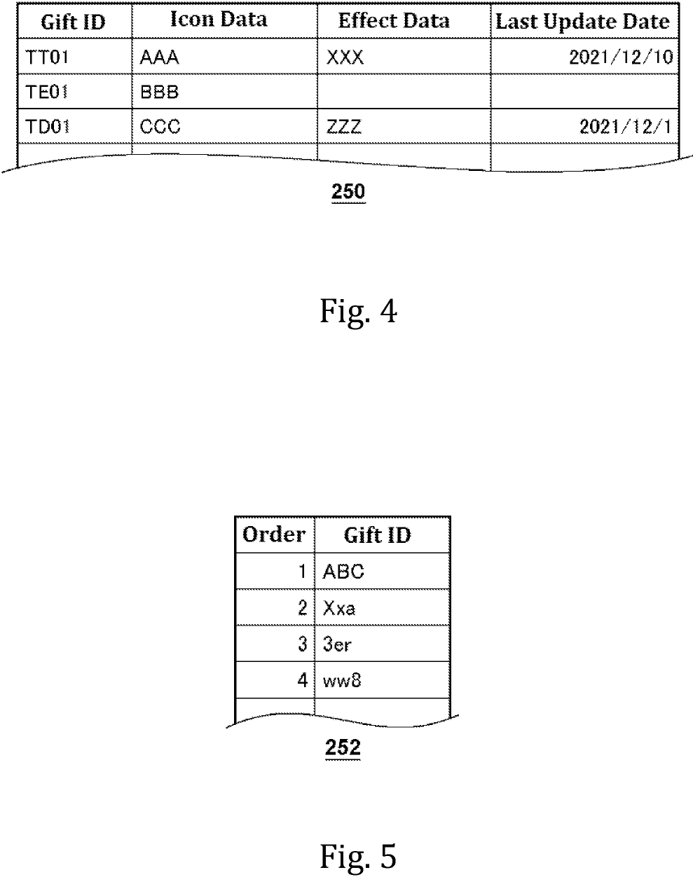

FIG. 4 is a data structure diagram showing an example of a terminal-side gift holding unit 250 of FIG. 3. The terminal-side gift holding unit 250 holds information on gifts that the user terminal 20 has downloaded. A gift is electronic data with the following characteristics:
It can be purchased in exchange for the points (later described in detail), or can be given for free.
It can be given by a viewer to a distributor. Giving a gift to a distributor is referred to as using the gift or throwing the gift.
Some gifts may be purchased and used at the same time, and some gifts may be purchased or given and then used at any time later by the purchaser or recipient viewer.
When a viewer gives a gift to a distributor, the distributor is awarded the amount of points corresponding to the gift and an effect associated with the gift is exerted. For example, an effect corresponding to the gift will appear on the live-streaming screen.

The terminal-side gift holding unit 250 stores a gift ID for identifying a gift, data of an icon that is an object representing the gift (hereinafter referred to as icon data), data for realizing an effect corresponding to the gift (hereinafter referred to as “effect data”), and last modified date, which is the date when the gift was last used, in association with each other. A viewer is able to present a desired gift to a distributor by paying the price or value equivalent to the gift while viewing the live-stream. The payment of the equivalent value may be made by an appropriate electronic payment means. For example, the payment may be made by the viewer paying points corresponding to the equivalent value to the administrator. Alternatively, bank transfers or credit card payments may be used.

The effect is a visual or auditory or tactile effect (e.g., vibration) or a combination thereof that characterizes a gift. Examples of the visual effect include animation, images, and flashing/blinking. Examples of the auditory effect include sound effects and voice. The effect data is data for realizing such an effect on the user terminal 20, and the user terminal 20 realizes such an effect by processing the effect data. Since the technique for realizing the effect data itself is known, it will not be hereunder described in detail.

The gift IDs and icon data of all gifts are stored in advance in the terminal-side gift holding unit 250. The gift information transmission-reception unit 206 downloads the effect data of gifts from the server 10 and stores it in the terminal-side gift holding unit 250. There are some gifts for which the gift information transmission-reception unit 206 has not downloaded their effect data from the server 10.

FIG. 5 is a data structure diagram showing an example of the download queue holding unit 252 of FIG. 3. The download queue holding unit 252 holds queues for gift downloads. The download queue holding unit 252 holds the download order and the gift ID in association with each other. The gift information transmission-reception unit 206 refers to the download queue holding unit 252, sequentially requests the effect data of the gifts from the server 10 according to the order of the queue, and downloads the effect data from the server 10.

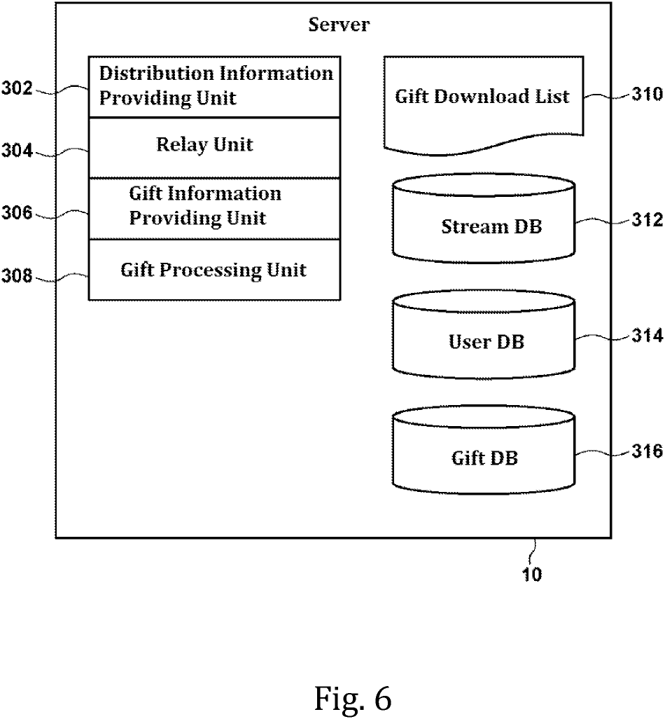

FIG. 6 is a block diagram showing functions and configuration of the server of FIG. 1. The server 10 has a distribution information providing unit 302, a relay unit 304, a gift information providing unit 306, a gift processing unit 308, a gift download list 310, a stream DB 312, a user DB 314, and a gift DB 316.

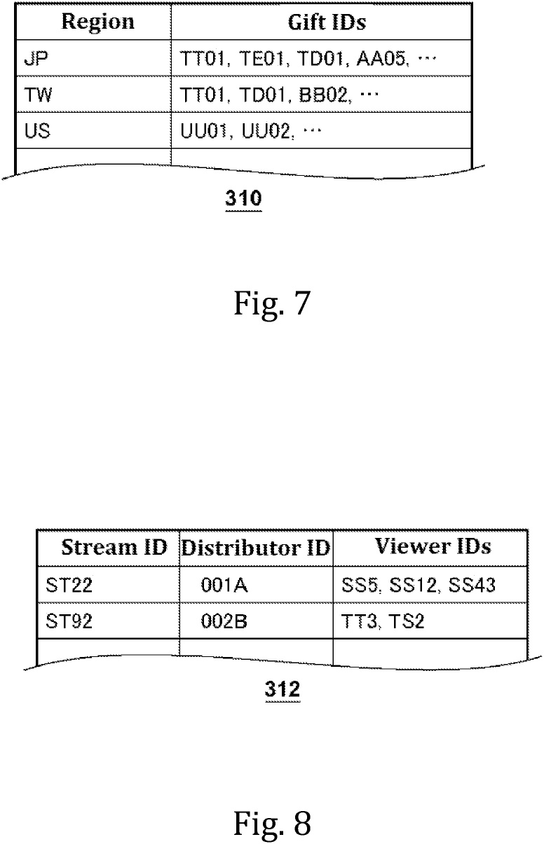

FIG. 7 is a data structure diagram showing an example of the gift download list 310 of FIG. 6. The gift download list 310 is a list that specifies gifts for which the user terminals 20 and 30 must download the effect data by default. The effect data of the gifts with the gifts ID that are included in the gift download list 310 is automatically downloaded to the user terminals 20 and 30 when the live-streaming application is opened on the user terminals 20 and 30. Specifically, the effect data is downloaded without the user’s instruction and stored in the terminal-side gift holding unit 250. The gift download list 310 has an item of region, and gifts to be downloaded are listed for each region to which the user terminal belongs.

The gift download list 310 stores the gift IDs of the gifts to be downloaded in association with the regions. The gift download list 310 is configured to be updatable. The administrator of the live-streaming system is able to change the contents of the gift download list 310 via the server 10. The administrator may register gifts (event-related gifts, etc.) that are expected to be used frequently in the gift download list 310 in advance. In addition, the administrator may remove infrequently used gifts from the gift download list 310.

FIG. 8 is a data structure diagram of an example of the stream DB 312 of FIG. 6. The stream DB 312 holds information regarding a live-stream currently taking place. The stream DB 312 stores a stream ID for identifying a live- stream on a live distribution platform provided by the live-streaming system 1, a distributor ID for identifying the distributor who provides the live-stream, and a viewer ID for identifying a viewer of the live-stream, in association with each other.

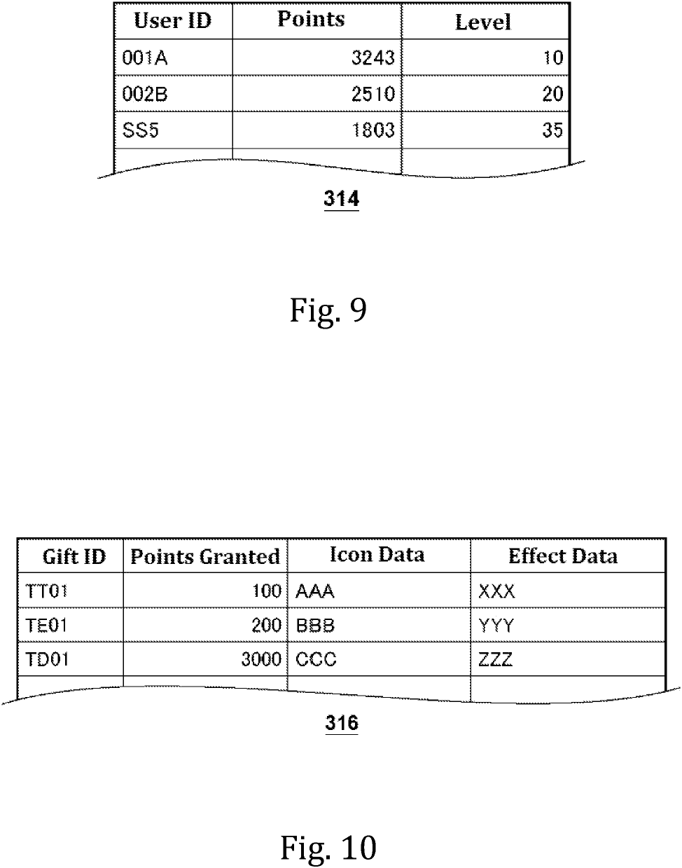

FIG. 9 is a data structure diagram showing an example of the user DB 314 of FIG. 6. The user DB 314 holds information regarding users. The user DB 314 stores a user ID for identifying a user, points that the user has, and the level of the user, in association with each other. The point is the electronic value circulated within the live-streaming platform. When a distributor receives a gift from a viewer during a live-stream, the distributor’s points increase by the value of the gift. The points are used, for example, to determine the amount of reward or money the distributor receives from the administrator of the live-streaming platform. The level is an indicator of the amount of user activity on the live-streaming platform. The level of the user is raised by giving gifts as a viewer, performing live-streams as a distributor, participating in events, and the like. The server 10 calculates the level of the user from the history of the user’s activity.

FIG. 10 is a data structure diagram showing an example of the gift DB 316 of FIG. 6. The gift DB 316 stores the icon data and the effect data of all gifts. The gift DB 316 stores a gift ID for identifying a gift, the amount of points that are granted to a distributor when the gift is given to the distributor, the icon data for the gift, and the effect data for the gift, in association with each other.

Referring again to FIG. 6, Upon reception of a notification from the user terminal 20 on the distributor side to start a live-stream over the network NW, the distribution information providing unit 302 registers a stream ID for identifying this live-stream and the distributor ID of the distributor who performs the live-stream in the stream DB 312. When the distribution information providing unit 302 receives a request to provide information about live-streams from the viewing unit 200 of the user terminal 30 on the viewer side over the network NW, the distribution information providing unit 302 retrieves currently available live-streams from the stream DB 312 and makes a list of the available live-streams. The distribution information providing unit 302 transmits the list to the requesting user terminal 30 over the network NW. The viewer-side UI control unit 202 of the requesting user terminal 30 generates a live-stream selection screen based on the received list and displays it on the display of the user terminal 30.

Once the viewer-side UI control unit 202 of the user terminal 30 receives the viewer’s selection result of the live-stream on the live-stream selection screen, the input information transmission unit 206 generates a distribution request including the stream ID of the selected live-stream, and transmits the request to the server 10 over the network NW. The distribution information providing unit 302 starts providing, to the requesting user terminal 30, the live-stream specified by the stream ID included in the received distribution request. The distribution information providing unit 302 updates the stream DB 312 to include the viewer ID of the viewer of the requesting user terminal 30 into the viewer IDs of the stream ID.

The relay unit 304 relays the transmission of the video data from the distributor-side user terminal 20 to the viewer-side user terminal 30 in the live-streaming started by the distribution information providing unit 302. The relay unit 304 receives from the viewer-side UI control unit 202 a signal that represents user input by the viewer during reproduction of the video data on the viewer-side user terminal 30. The signal representing user input includes a gift DL request signal for requesting download of the effect data of a gift and a gift usage signal representing the use of a gift. The gift DL request signal includes the gift ID of the gift to be downloaded. The gift usage signal includes the viewer ID of a viewer, the distributor ID of a distributor to whom a gift is given (the distributor ID of the distributor performing the live-stream that is being viewed by the viewer who gave the item), and the gift ID of the gift.

The gift information providing unit 306 provides information on gifts to the user terminals 20 and 30. The gift information providing unit 306 transmits, to the user terminal, the gift download list for the terminal in response to a request from the user terminals. The gift information providing unit 306 obtains, from the gift DB 316, the effect data corresponding to the gift ID included in the gift DL request signal that has been received by the relay unit 304. The gift information providing unit 306 transmits the obtained effect data to the requesting user terminal as a response to the gift DL request signal.

The gift processing unit 308 updates the user DB 314 so as to increase the points of the distributor depending on the points of the gift identified by the gift ID included in the gift usage signal. Specifically, the gift processing unit 308 refers to the gift DB 316 to specify the points to be granted for the gift ID included in the received gift usage signal. The gift processing unit 308 then updates the user DB 314 to add the determined points to the points of the distributor ID included in the gift usage signal.

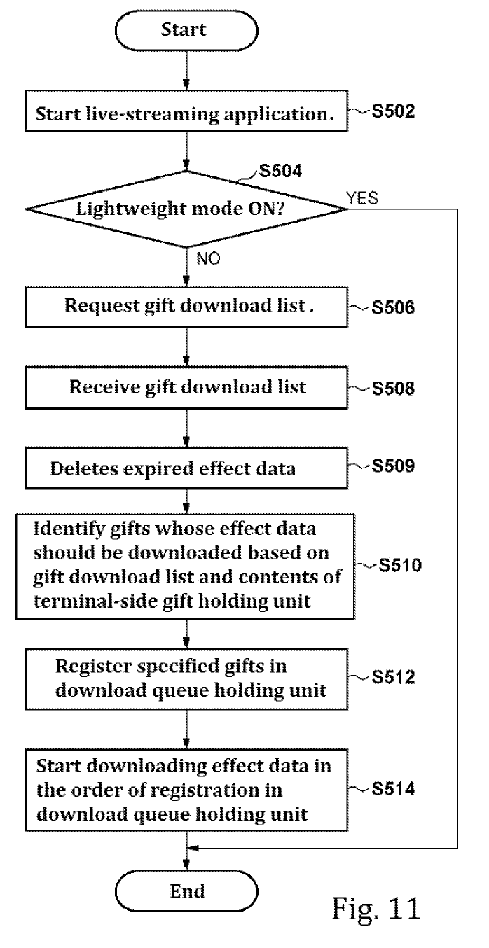

The operation of the live-streaming system 1 with the above configuration will be now described. FIG. 11 is a flowchart showing steps of an application activation process on the user terminals 20 and 30. Once a user taps the icon of the live-streaming application, the live-streaming application is opened on the user terminal (S502). The user terminal determines whether a lightweight mode is turned ON (S504). The lightweight mode is a mode configuring all the gifts for which effect data is not stored in the terminal-side gift holding unit 250 as the load-required type gifts at the time of start of the application. The user terminal holds the ON/OFF state of the lightweight mode by a mode holding unit (not shown). The user terminal switches ON/OFF of the lightweight mode according to an instruction from the user. When the lightweight mode is ON (YES in S504), the user terminal ends the application startup process without updating the download queue.

When the lightweight mode is OFF (NO in S504), the gift information transmission-reception unit 206 requests the gift download list from the server 10 (S506). The gift information transmission-reception unit 206 generates a list request signal including the user ID of the user of the user terminal and the region to which the user terminal belongs, and transmits the list request signal to the server 10 over the network NW The gift information providing unit 306 determines whether the attribute of the user with the user ID that is included in the received list request signal satisfies a predetermined criterion. When the criterion is met, the gift information providing unit 306 generates a gift download list for the terminal such that the list includes all gift IDs registered in the gift DB 316. Specifically, the gift information providing unit 306 refers to the user DB 314 and specifies the level for the user ID included in the received list request signal. When the specified level exceeds a threshold value, the gift information providing unit 306 generates the gift download list for the terminal such that the list includes all gift IDs registered in the gift DB 316. When the criterion is not met, the gift information providing unit 306 refers to the gift download list 310 and generates a gift download list for the terminal such that the list includes the gift IDs for the region included in the received list request signal. The gift information providing unit 306 transmits the generated gift download list for the terminal to the user terminal over the network NW. The gift information transmission-reception unit 206 of the user terminal 20 receives the gift download list for the terminal (S508).

The gift determination unit 208 deletes expired effect data from the terminal-side gift holding unit 250 based on the received gift download list for the terminal and the last modified date of each gift (S509). The gift determination unit 208 refers to the terminal-side gift holding unit 250, and identifies a gift ID with which the difference between the last modified date and the current date exceeds a threshold value (for example, 14 days). The gift determination unit 208 determines whether the specified gift ID is included in the received gift download list for the terminal. When the specified gift ID is not included in the gift download list for the terminal, the gift determination unit 208 deletes the effect data for the gift ID from the terminal-side gift holding unit 250. The gift determination unit 208 does not delete the specified gift ID when the specified gift ID is included in the gift download list for the terminal. It can be said that the gift determination unit 208 deletes the effect data of the gifts that satisfy the predetermined deletion criterion and are not included in the gift download list for the terminal. In this way, it is possible to suppress an increase in the size of the terminal-side gift holding unit 250 while ensuring the immediacy of the interaction by maintaining the effect data of the preloaded type gifts.

The gift determination unit 208 specify a gift(s) whose effect data should be downloaded based on the received terminal-side gift download list and the contents of the terminal-side gift holding unit 250 (S510). For each gift ID included in the terminal-side gift download list, when the effect data for the gift ID is not held in the terminal-side gift holding unit 250, the gift-determining unit 208 specifies the gift ID as the gift ID of the gift to be downloaded. The gift determination unit 208 registers the specified gift IDs in the download queue holding unit 252 in a predetermined or any order (S512). The gift information transmission-reception unit 206 starts downloading such effect data in the order that the effect data is registered in the download queue holding unit 252 (S514).

In the above flow, the gift information transmission-reception unit 206 starts downloading the effect data for the preloaded type gifts, that is, the effect data for the gifts included in the gift download list for the terminal, before icons of the gifts are specified without an instruction from the user. The gift determination unit 208 identifies the preloaded type gifts by referring to the gift download list for the terminal.

When the user’s attributes meet the predetermined criterion in step S506, the gift download list for the terminal includes the gift IDs of all the gifts, so that the gift information transmission-reception unit 206 starts downloading the effect data for the gifts regardless of the gift type without any instruction from the user.

In the above flow, since the gift IDs of the load-required type gifts are not included in the gift download list for the terminal, the download of effect data for a load-required type gift is not started before this gift is specified by the user. However, this does not apply when the gift is used by another user as described later.

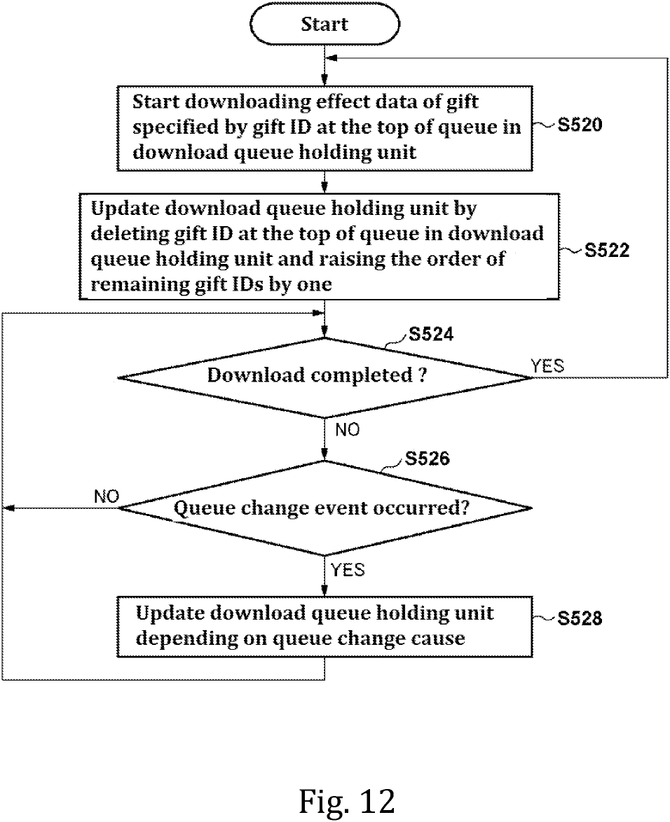

FIG. 12 is a flowchart showing steps of a download process performed on the user terminals 20 and 30. The gift information transmission-reception unit 206 of the user terminal starts downloading the effect data of the gift specified by the gift ID at the top of the queue in the download queue holding unit 252 (S520). The gift information transmission-reception unit 206 generates a gift DL request signal that includes the highest gift ID among the gift IDs held in the download queue holding unit 252, that is, the first gift ID in the queue, and transmits the gift DL request signal to the server 10 over the network NW.

The queue control unit 210 updates the download queue holding unit 252 by deleting the gift ID at the top of the queue in the download queue holding unit 252 and raising the order of the remaining gift IDs by one (S522). For example, in the download queue holding unit 252, the second gift ID is raised to the first or top of the queue, and the third gift ID is raised to the second in the queue.

The gift information transmission-reception unit 206 determines whether the download is completed (S524). When completed (YES in S524), the gift information transmission- reception unit 206 registers the downloaded effect data in the terminal-side gift holding unit 250, and the process returns to step S520. When not completed (NO in S524), the queue control unit 210 determines whether a queue change event has occurred (S526). There may be two following causes to change the queue.

(Cause 1) The user has indicated his/her intention to use a load-required type gift or a preloaded type gift that has not been downloaded yet. Specifically, an icon of such a gift was tapped by the user.

(Cause 2) Another viewer of another user terminal to which the same live-stream video data is streamed has used a load-required type gift or a preloaded type gift that has not been downloaded yet.

When there is no such a cause occurred to change the queue (NO in S526), the process returns to step S524. When such a queue change cause occurs (YES in S526), the queue control unit 210 updates the download queue holding unit 252 depending on the queue change cause (S528). The process then returns to step S524.

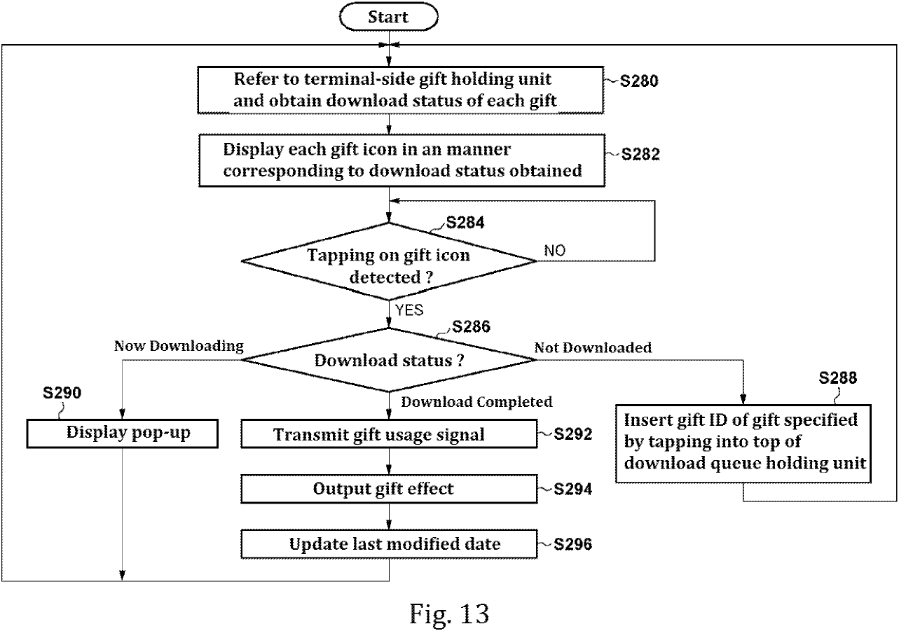

Step S528 will be described in detail. Cause 1 will be described later with reference to FIG. 13. Cause 2 will be described with reference to the example of FIG. 2. The distributor LV distributes the live-stream, and the viewer AU1 and the viewer AU2 are viewing the same live-stream. Here, when the viewer AU2 uses a gift, a gift usage signal that includes the gift ID of the gift is generated by the user terminal 30b and transmitted to the server 10 over the network NW At the same time, the user terminal 30b processes effect data for the gift to superimpose and display the effect on the video image VD2. By referring to the stream DB 312, the server 10 identifies another viewer(s) who is (are) viewing the same live-stream as the live-stream that the viewer AU2 is viewing. The server 10 generates a gift notification signal that includes the gift ID included in the received gift usage signal, and transmits the gift notification signal to the user terminal 30a of the specified another viewer (here, the viewer AU1) over the network NW. The user terminal 30a determines whether the effect data for the gift ID included in the received gift notification signal is held in the terminal-side gift holding unit 250. When the effect data is held, the user terminal 30a processes the effect data to superimpose and display the same effect as the effect of the user terminal 30b on the video image VD1. Whereas when the effect data is not held, the user terminal 30b determines that Cause 2 has occurred.

The queue control unit 210 controls the download queue holding unit 252 such that the following priority relationship is established for the gift downloads.

First Priority: Download effect data for a gift related to Cause 1.

Second Priority: Download effect data for a gift related to Cause 2.

Third Priority: Download effect data for a gift registered in the download queue holding unit 252 when the live-streaming application is started.

When Cause 1 occurs, the queue control unit 210 moves down the order of all the gift IDs held in the download queue holding unit 252 by one, and inserts the gift ID of the gift related to Cause 1 in the first place or top of the queue. That is, the queue control unit 210 wedges the gift ID of the gift related to Cause 1 to the top of the download queue. For example, in the download queue holding unit 252, the first gift ID is descended to the second in the queue, the second gift ID is descended to the third in the queue, and the gift ID of the gift related to Cause 1 is registered first in the queue. As a result, download of the effect data of the gift related to the Cause 1 will be started following the download currently in progress.

When Cause 2 occurs, the queue control unit 210 moves down the order of all the gift IDs held in the download queue holding unit 252 by one except for the gift ID of the gift related to Cause 1. In addition, the gift ID of the gift related to Cause 2 is inserted into the entry directly under the gift ID of the gift related to Cause 1. That is, the queue control unit 210 interrupts the download queue by inserting the gift ID of the gift related to Cause 2 between the gift ID of the gift related to Cause 1 and the other gift IDs in the download queue. For example, in the download queue holding unit 252, the gift ID related to Cause 1 whose order was the first remains in the first place in the queue, the gift ID whose order was the second is moved to the third in the queue, and the gift related to Cause 2 is registered in the second place in the queue.

FIG. 13 is a flowchart showing steps of a gift usage process on the user terminals 20 and 30. In the example, it is assumed that the viewer accesses the live-stream platform from the user terminal 30, selects a desired live-stream on the live-stream selection screen, and starts viewing the selected live-stream. While the viewer is watching the live-stream, the video data is continuously transmitted from the distributor’s user terminal 20 to the viewer’s user terminal 30 via (the relay unit 304 of) the server 10.

During the reproduction of the video data, the viewer performs user input for requesting display of an item via input means of the user terminal 30. Upon reception of this user input, the viewing-side UI control unit 202 of the user terminal 30 refers to the terminal-side gift holding unit 250 and obtains the download status of each gift (S280). The download status includes “download completed” when the effect data is held in the terminal-side gift holding unit 250, “not downloaded” when the effect data is not held in the terminal-side gift holding unit 250, and “now downloading” when the download of the effect data is currently in progress.

The viewer-side UI control unit 202 and the superimposed information generation unit 204 display each gift icon in a manner corresponding to the download status obtained in step S280 (S282). The superimposed information generation unit 204 generates a gift icon for each gift by obtaining icon data from the terminal-side gift holding unit 250 and processing the data. The superimposed information generation unit 204 imparts, to the generated gift icon, a visual effect according to the download status obtained in step S280. For example, when the download status is “now downloading”, the superimposed information generation unit 204 associates an indicator indicating the download status with the corresponding gift icon. For example, the superimposed information generation unit 204 adds a progress bar indicating the progress of download to the gift icon. When the download status is “not downloaded”, the superimposed information generation unit 204 determines whether the gift is in the download queue by referring to the download queue holding unit 252. When the gift is in the download queue, the superimposed information generation unit 204 gives, to the corresponding gift icon, a visual effect (shading, etc.) indicating that the gift is waiting for download. When the gift is not in the download queue, the superimposed information generation unit 204 put a mark to the corresponding gift icon to indicate that download is necessary. When the download status is “download completed”, the superimposed information generation unit 204 does not give a visual effect to the corresponding gift icon. The superimposition information generation unit 204 superimposes the processed or unprocessed gift icon thus generated on the image of the video data obtained from the server 10. The viewer-side UI control unit 202 displays the image on which the gift icon is superimposed on the display.

The viewing side UI control unit 202 waits until it detects tapping on the gift icon shown on the display in step S282 (S284). If the download status is changed during waiting (for example, “now downloading” turns to “download completed”, or the queued “not downloaded” turns to “now downloading” and then turns to “download completed”), the visual effect of the gift icon also changes as the download status changes. When tapping on the gift icon is detected (YES in S284), the gift determination unit 208 determines the download status of the gift corresponding to the gift icon specified through the tapping, “not downloaded”, “download completed”, or “now downloading” (S286).

When the download status is “not downloaded”, the queue control unit 210 inserts the gift ID of the gift specified by tapping the corresponding icon into the top of the queue in the download queue holding unit 252 (S288). This corresponds to the case where the above Cause 1 occurs. Thereafter the process returns to step S280. As a result, download of the effect data of the gift specified by tapping is started with the highest priority.

When the download status is “now downloading”, the viewer UI control unit 202 displays, on the display, a pop-up that includes text indicating that the effect data of the gift specified by tapping is being downloaded. The text may be, for example, “Now loading. When loading is complete, tap the icon to present the gift.” The process then returns to step S280.

When the download status is “DL completed”, the gift information transmission-reception unit 206 generates a gift usage signal that includes the gift ID of the gift specified by tapping, and transmits the gift usage signal to the server 10 over the network NW (S292). The superimposed information generation unit 204 and the viewer-side UI control unit 202 outputs the gift effect by reading the gift effect data specified by tapping from the terminal-side gift holding unit 250 and processing it (S294). The gift determination unit 208 accesses the terminal-side gift holding unit 250 and updates the last modified date of the gift specified by tapping to the current date (S296). The process then returns to step S280.

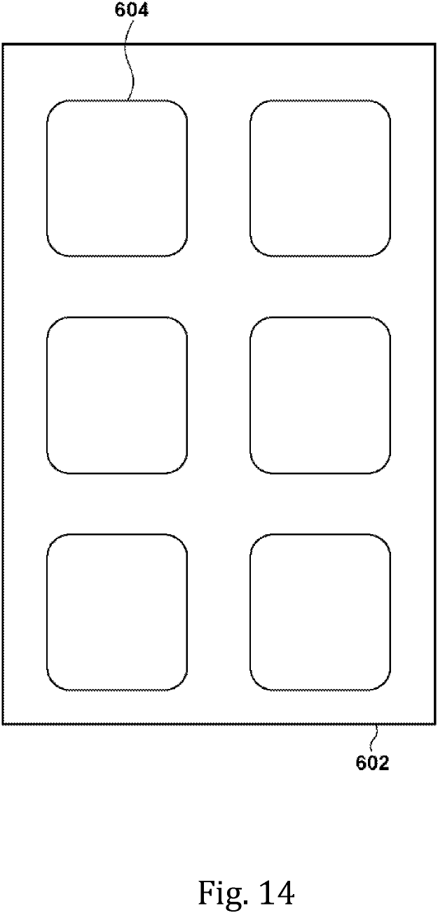

FIG. 14 is a representative screen image of the live-stream selection screen 602 displayed on the display of the viewer user terminal 30. The live-stream selection screen 602 includes thumbnails 604 indicating live-streams in the list of currently available live streams. The viewer-side UI control unit 202 generates the live-stream selection screen 602 based on the list of live-streams obtained from the server 10 and shows the screen on the display.

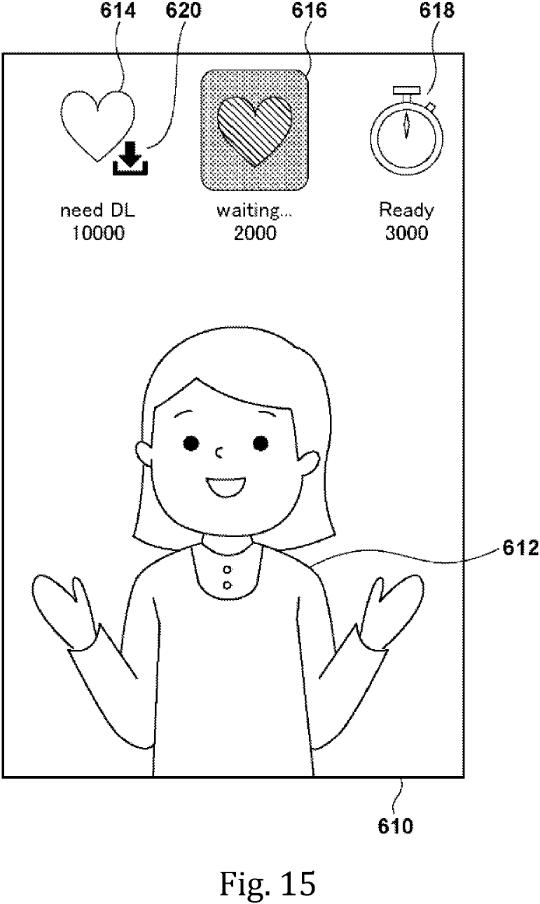

FIG. 15 is a representative screen image of a live-streaming room screen 610 shown on the display of the viewer user terminal 30. Once the viewer taps a thumbnail on a live-stream selection screen 602 of FIG. 14, the live-streaming room screen 610 of FIG. 15 is shown on the display. The live-streaming room screen 610 includes a distributor image 612 obtained by reproducing the video data, and gift icons 614, 616, and 618.

The gift icon 614 is a gift icon for a gift whose download status is “not downloaded” and which is not registered in the download queue holding unit 252. The gift icon 614 has a mark 620 indicating that download is required. The gift represented by this gift icon 614 is a load-required type gift.

The gift icon 616 is a gift icon for a gift whose download status is “not downloaded” and which is registered in the download queue holding unit 252. The gift icon 616 is shaded to indicate that it is waiting for download. The gift represented by this gift icon 616 is basically a preloaded type gift that has not yet been downloaded.

The gift icon 618 is a gift icon for a gift whose download status is “download completed”. The gift represented by this gift icon 618 is: (1) a preloaded type gift for which effect data has been downloaded; and (2) a load-required type gift for which effect data has been downloaded as the user uses the gift or the gift is specified by other user. Since the effect data of the gift (2) has already been downloaded, it is no longer the load-required type gift. However, when the corresponding effect data has expired and the gift is deleted from the terminal-side gift holding unit 250, the gift again becomes the load-required type gift.

Once the viewer taps the gift icon 618 on the live-streaming room screen 610 of FIG. 15, the user terminal 30 accepts the designation of the special gift icon 618 by the viewer. The user terminal 30 realizes the effect for the gift icon 618 by reading effect data for the gift represented by the designated gift icon 618 from the terminal-side gift holding unit 250 and processing the effect data.

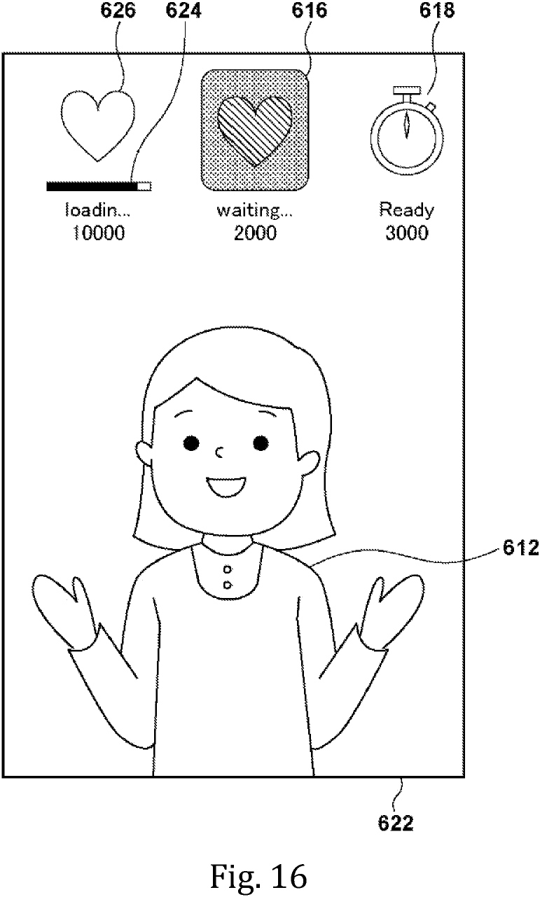

FIG. 16 is a representative screen image of a live-streaming room screen 622 shown on the display of the viewer user terminal 30. Once the viewer taps the gift icon 614 on the live-streaming room screen 610 of FIG. 15, the user terminal 30 accepts the selection of the gift icon 614 by the viewer. The user terminal 30 then starts downloading the effect data for the gift represented by the specified gift icon 614 (hereinafter referred to as a user-designated gift). In the live-streaming room screen 622 of FIG. 16, the gift icon 614 of FIG. 15 is changed to a gift icon 626 that includes a progress bar 624 indicating the progress of the download instead of the mark 620.

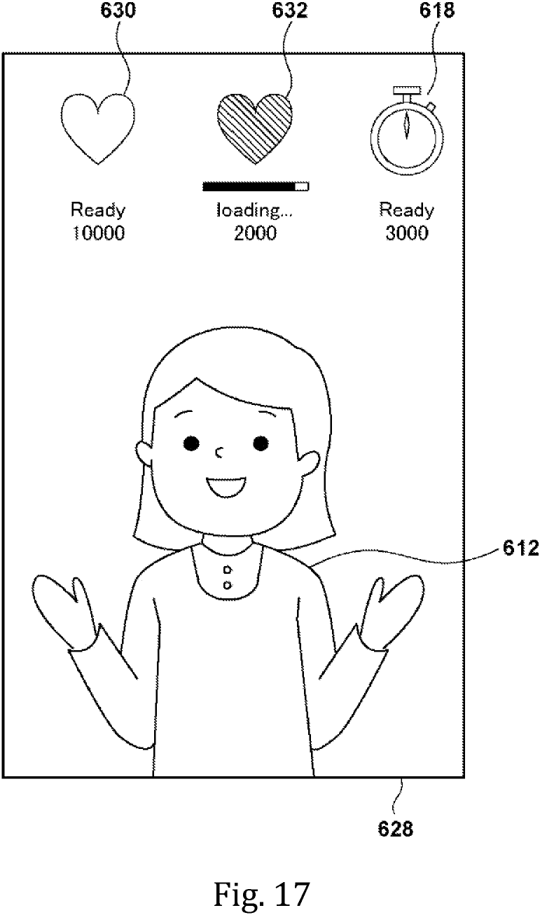

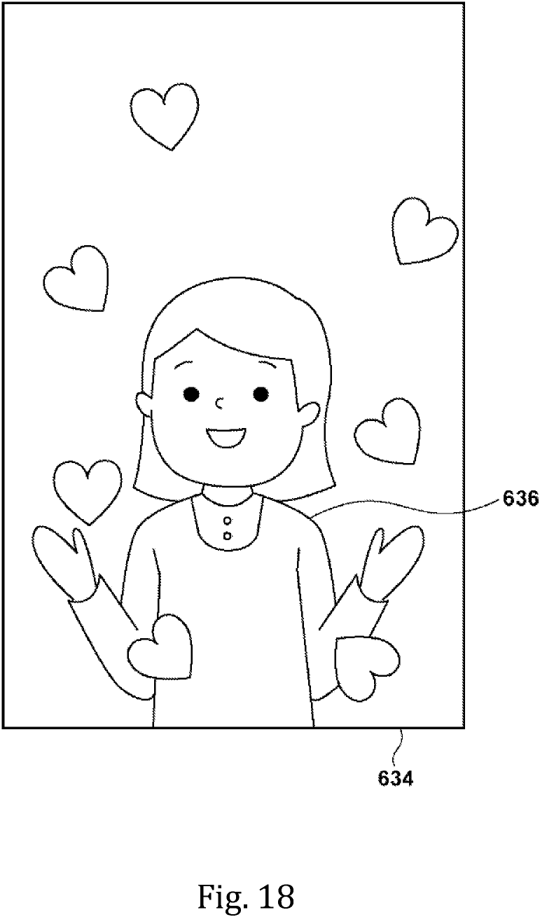

FIG. 17 is a representative screen image of a live-streaming room screen 628 shown on the display of the viewer user terminal 30. Since the time has passed from the state of FIG. 15 and the download of the effect data of the user-specified gift has been completed, the gift icon 630 of the user-specified gift on the live-streaming room screen 628 of FIG. 16 is shown as the gift icon whose download status is “download completed”. Download of the effect data for the gift represented by the gift icon 616 on the live-streaming room screen 610 of FIG. 15 is now in progress, the gift icon 632 of the gift includes the progress bar.

FIG. 18 is a representative screen image of a live-streaming room 634 shown on the display of the viewer user terminal 30. Once the viewer taps the gift icon 630 on the live-streaming room screen 628 of FIG. 17, the user terminal 30 displays the live-streaming room screen 634 that includes a distributor image 636 on which the effect of the user-specified gift is superimposed on the display.

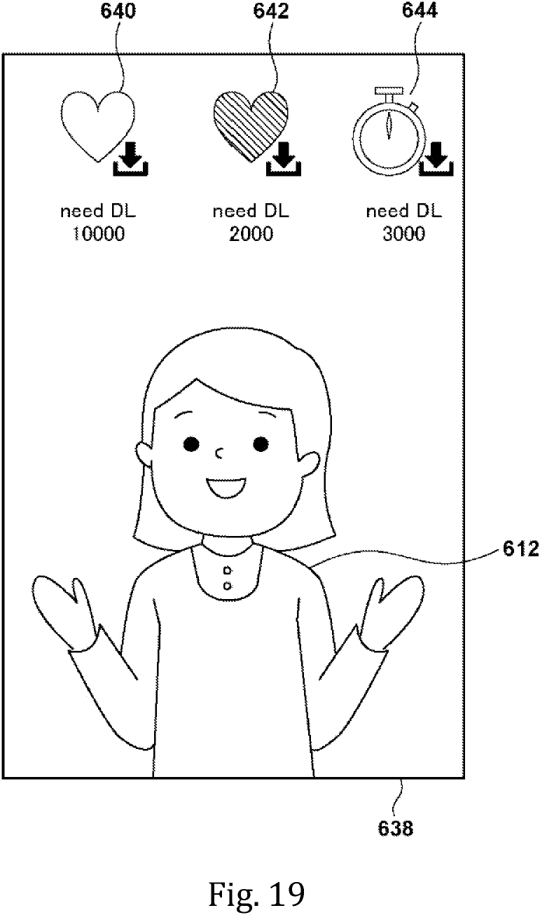

FIG. 19 is a representative screen image of a live-streaming room screen 638 shown on the display of the viewer user terminal 30. The lightweight mode is ON on the live-streaming distribution screen 638. Since there are no preloaded type gifts in the lightweight mode, gift icons 640, 642, and 644 displayed on the live-streaming room screen 638 all have the download status of “not downloaded” and the corresponding gifts are not registered in the download queue holding unit 252. The gift icons each have a mark indicating that download is required. The gifts represented by these gift icons are load-required type gifts.

In the above embodiment, an example of the holding unit includes a hard disk or semiconductor memory. It is understood by those skilled in the art that each element or component can be realized by a CPU not shown, a module of an installed application program, a module of a system program, or a semiconductor memory that temporarily stores the contents of data read from the hard disk, and the like.

The live-streaming system 1 in the embodiment does not download the effect data for all the gifts in advance but download the effect data for the specified preloaded-type gifts in advance. Download of effect data for the remaining load-required type gifts is triggered by the user’s specification of the load-required type gift(s). In this way, it is possible to suppress an increase in the amount of communication caused by downloading and an increase in the capacity required for installing the live-streaming application while realizing a richer effect by using a large effect data.

Further, in the live-streaming system1 in the embodiment, when a viewer taps the preloaded type gift, its effect is immediately exerted on the screen of the distributor, the screen of the viewer, and the screens of another viewers. Therefore, the immediacy of the interaction between the distributor and the viewers can be maintained.

In one example, the total amount of effect data is several tens of gigabytes (GB). By applying the technical idea of the present embodiment, the amount of effect data held by the user terminal can be reduced to several gigabytes to several hundred megabytes (MB). Further, it takes several tens of milliseconds to several seconds to download a piece of typical effect data in a typical communication environment, but the adverse effect on the user experience due to such a delay is limited. Therefore, in many cases, the advantages of providing the load-required type outweigh the disadvantages.

Further, in the live-streams system 1 in the embodiment, the gifts that have been downloaded and the gifts that have not been downloaded yet are displayed in different modes. Therefore, the user can tell at a glance the download status of the gifts, which improves user convenience. In particular, as a characteristic of live-streaming, there are often situations where a user wishes to present a gift immediately on the spot, and in such a situation, the user can easily select a downloaded gift while avoiding the gifts that have not been downloaded yet. This improves user experience.

Further, in the live-streaming system 1 in the embodiment, download of the effect data for the gift specified by the user has priority over the automatic download of the preloaded type gifts. In this way, it is possible to reduce the time that the user has to wait for using a gift, and thus it is possible to increase the satisfaction of the user.

Further, in the live-streaming system 1 in the embodiment, download of the effect data for the gift used by other user has a higher priory than the automatic download of the preloaded type gifts. In this way, the delay in the effect output can be reduced, so that it is possible to reduce the unpleasant feeling caused by, for example, gap of timing between when the distributor says thank you and when the effect is exerted.

Further, in the live-streaming system 1 in the embodiment, all gifts are preloaded for users whose attributes satisfy a predetermined criterion. This allows, for example, to maximize the user experience of users who have been using the live distribution platform for a long time and / or who have a high total billing amount by preloading all the gifts. Alternatively, since the user terminals of so-called heavy users are likely to have high functionality and large capacity, the user experience can be maximized by preloading all gifts to such users.

### Hardware Configuration Example

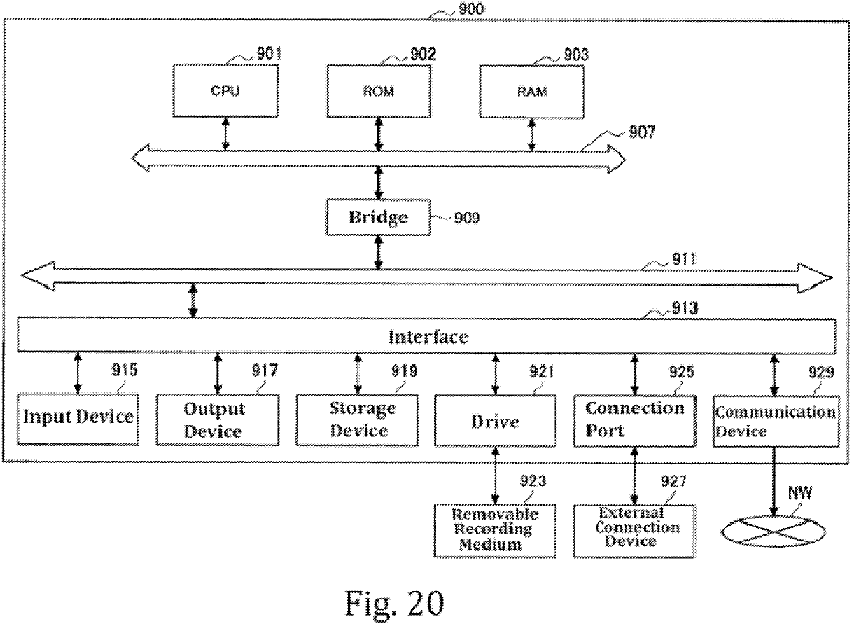

Referring to FIG. 20, the hardware configuration of the information processing device will be now described. FIG. 20 is a block diagram showing an example of a hardware configuration of the information processing device according to the embodiment. The illustrated information processing device 900 may, for example, realize the server 10 and the user terminals 20 and 30 in the embodiment.

The information processing device 900 includes a CPU 901, ROM (Read Only Memory) 903, and RAM (Random Access Memory) 905. The information processing device 900 may also include a host bus 907, a bridge 909, an external bus 911, an interface 913, an input device 915, an output device 917, a storage device 919, a drive 921, a connection port 925, and a communication device 929. In addition, the information processing device 900 includes an image capturing device such as a camera (not shown). In addition to or instead of the CPU 901, the information processing device 900 may also include a DSP (Digital Signal Processor) or ASIC (Application Specific Integrated Circuit).

The CPU 901 functions as an arithmetic processing device and a control device, and controls all or some of the operations in the information processing device 900 according to various programs stored in the ROM 903, the RAM 905, the storage device 919, or the removable recording medium 923. For example, the CPU 901 controls the overall operation of each functional unit included in the server 10 and the user terminals 20 and 30 in the embodiment. The ROM 903 stores programs, calculation parameters, and the like used by the CPU 901. The RAM 905 serves as a primary storage that stores a program used in the execution of the CPU 901, parameters that appropriately change in the execution, and the like. The CPU 901, ROM 903, and RAM 905 are interconnected to each other by a host bus 907 which may be an internal bus such as a CPU bus. Further, the host bus 907 is connected to an external bus 911 such as a PCI (Peripheral Component Interconnect / Interface) bus via a bridge 909.

The input device 915 may be a user-operated device such as a mouse, keyboard, touch panel, buttons, switches and levers, or a device that converts a physical quantity into an electric signal such as a sound sensor typified by a microphone, an acceleration sensor, a tilt sensor, an infrared sensor, a depth sensor, a temperature sensor, a humidity sensor, and the like. The input device 915 may be, for example, a remote control device utilizing infrared rays or other radio waves, or an external connection device 927 such as a mobile phone compatible with the operation of the information processing device 900. The input device 915 includes an input control circuit that generates an input signal based on the information inputted by the user or the detected physical quantity and outputs the input signal to the CPU 901. By operating the input device 915, the user inputs various data and instructs operations to the information processing device 900.

The output device 917 is a device capable of visually or audibly informing the user of the obtained information. The output device 917 may be, for example, a display such as an LCD, PDP, or OELD, etc., a sound output device such as a speaker and headphones, and a printer. The output device 917 outputs the results of processing by the information processing unit 900 as text, video such as images, or sound such as audio.

The storage device 919 is a device for storing data configured as an example of a storage unit of the information processing equipment 900. The storage device 919 is, for example, a magnetic storage device such as a hard disk drive (HDD), a semiconductor storage device, an optical storage device, or an optical magnetic storage device. This storage device 919 stores programs executed by the CPU 901, various data, and various data obtained from external sources.

The drive 921 is a reader/writer for a removable recording medium 923 such as a magnetic disk, an optical disk, a photomagnetic disk, or a semiconductor memory, and is built in or externally attached to the information processing device 900. The drive 921 reads information recorded in the mounted removable recording medium 923 and outputs it to the RAM 905. Further, the drive 921 writes record in the attached removable recording medium 923.

The connection port 925 is a port for directly connecting a device to the information processing device 900. The connection port 925 may be, for example, a USB (Universal Serial Bus) port, an IEEE1394 port, an SCSI (Small Computer System Interface) port, or the like. Further, the connection port 925 may be an RS-232C port, an optical audio terminal, an HDMI (registered trademark) (High-Definition Multimedia Interface) port, or the like. By connecting the external connection device 927 to the connection port 925, various data can be exchanged between the information processing device 900 and the external connection device 927.

The communication device 929 is, for example, a communication interface formed of a communication device for connecting to the network NW. The communication device 929 may be, for example, a communication card for a wired or wireless LAN (Local Area Network), Bluetooth (trademark), or WUSB (Wireless USB). Further, the communication device 929 may be a router for optical communication, a router for ADSL (Asymmetric Digital Subscriber Line), a modem for various communications, or the like. The communication device 929 transmits and receives signals and the like over the Internet or to and from other communication devices using a predetermined protocol such as TCP / IP. The communication network NW connected to the communication device 929 is a network connected by wire or wirelessly, and is, for example, the Internet, home LAN, infrared communication, radio wave communication, satellite communication, or the like. The communication device 929 realizes a function as a communication unit.

The image capturing device (not shown) is an imaging element such as a CCD (Charge Coupled Device) or CMOS (Complementary Metal Oxide Semiconductor), and a device that captures an image of the real space using various elements such as lenses for controlling image formation of a subject on the imaging element to generate the captured image. The image capturing device may capture a still image or may capture a moving image.

The configuration and operation of the live-streaming system 1 in the embodiment have been described. This embodiment is a merely example, and it is understood by those skilled in the art that various modifications are possible for each component and a combination of each process, and that such modifications are also within the scope of the present disclosure.

The technical idea according to the embodiment may be applied to live commerce or virtual live-streaming using an avatar that moves in synchronization with the movement of the distributor instead of the image of the distributor.

In the embodiment, when using the load-required type gift, first tap the gift icon of the gift to start downloading the effect data. After the download is completed, tap the gift icon again to use the gift. However, the embodiment is not limited to this. For example, when the user terminal detects tapping on a load-required type gift icon, it starts downloading the effect data for the gift represented by the gift icon. Upon completion of the download, processing for use of the gift may be automatically performed without further instruction from the user. In this case, the number of taps for using the gift is reduced, which reduces the user’s effort.

In the embodiment, the case where the download of the effect data of the load-required type gift is started when tapping on the gift icon of the load-required type gift is detected has been described. However the embodiment is not limited to this. For example, once the user terminal receives a request from the user to display the gift icon of a load-required type gift via the input means, the user terminal may start downloading the effect data for the gift.

In the embodiment, when the user has changed the region to which the user terminal belongs, the user terminal may delete the effect data for the gift(s) that is not included in the gift download list of the new region from the terminal-side gift holding unit 250.

In the embodiment, the case where the user terminal compares the gift download list with the contents of the terminal-side gift holding unit 250 has been described. However the embodiment is not limited to this. For example, when the live-streaming application is started, the user terminal refers to the terminal-side gift holding unit 250 to generate a list of gift IDs of gifts for which effect data exists and sends the list to the server 10. The server 10 compares the received list with the gift download list to specify the effect data to be downloaded to the user terminal. The server 10 transmits the gift ID(s) of the specified effect data to the user terminal. The user terminal registers the received gift ID (s) in the download queue holding unit 252 and starts downloading.

In the embodiment, when Cause 1 or Cause 2 occurs, the download of the effect data for the gift related to the cause is started after the ongoing download is completed. However the invention is not limited to this. For example, when Cause 1 or Cause 2 occurs, the user terminal may suspend or cancel the currently ongoing download and start downloading the effect data for the gift related to the cause.

The procedures described herein, particularly those described with a flow diagram, a flowchart, are susceptible of omission of part of the steps constituting the procedure, adding steps not explicitly included in the steps constituting the procedure, and/or reordering the steps. The procedure subjected to such omission, addition, or reordering is also included in the scope of the present invention unless diverged from the purport of the present invention.

At least some of the functions realized by the server 10 may be realized by a device(s) other than the server 10, for example, the user terminals 20 and 30. At least some of the functions realized by the user terminals 20 and 30 may be realized by a device(s) other than the user terminals 20 and 30, for example, the server 10. For example, the superimposition of a predetermined frame image on an image of the video data performed by the user terminal where the video data is reproduced may be performed by the server 10 or may be performed by the user terminal where the video data is generated.

What is claimed is:

1. A computer-readable tangible non-transitory storage medium storing a program causing a terminal to:
display a first user interface object representing a gift of a first type on a display while video data related to a live-stream is reproduced;
process data for realizing an effect for the gift represented by the first user interface object upon acceptance of selection of the first user interface object by a user of the terminal, the data being stored in a holding unit of the terminal;
display a second user interface object representing a gift of a second type on the display while the video data is reproduced; and
start download of data for realizing an effect for the gift represented by the second user interface object upon acceptance of selection of the second user interface object by the user.

2. The computer-readable tangible non-transitory storage medium of claim 1, wherein the program further causes the terminal to display an indicator indicating status of the download in association with the second user interface object on the display.

3. The computer-readable tangible non-transitory storage medium of claim 1, wherein the program further causes the terminal to start download of the data for realizing the effect for the gift of the first type before the selection of the first user interface object without an instruction from the user.

4. The computer-readable tangible non-transitory storage medium of claim 3,
wherein the starting the download of the data without the instruction from the user includes starting the download of the data for realizing the effect for the gift of the first type specified by referring a list before the selection of the first user interface object without the instruction from the user, and
wherein the list is configured to be updatable.

5. The computer-readable tangible non-transitory storage medium of claim 1 wherein the download of the data for realizing the effect for the gift of the second type is not started before the second user interface object is selected.

6. The computer-readable tangible non-transitory storage medium of claim 1 wherein the download of the data for realizing the effect for the gift of the second type has a higher priority than download of the data for realizing the effect for the gift of the first type.

7. The computer-readable tangible non-transitory storage medium of claim 1, wherein the program further causes the terminal to start download of data for realizing an effect for a gift used by another user of another terminal to which the video data is streamed,
wherein the download of the data for realizing the effect for the gift used by another user has a higher priority than the download of the data for realizing the effect for the gift of the first type, and
wherein the download of the data for realizing the effect for the gift of the second type has a higher priority than the download of the data for realizing the effect for the gift used by another user.

8. The computer-readable tangible non-transitory storage medium of claim 1, wherein the program further causes the terminal to start download of data for realizing effects for gifts without an instruction from the user, regardless of their gift types, when attributes of the user meet a predetermined criterion.

9. A terminal, comprising:
a holding unit;
a displaying unit displaying a first user interface object representing a gift of a first type on a display while video data related to a live-stream is reproduced;
a processing unit processing data for realizing an effect for the gift represented by the first user interface object upon acceptance of selection of the first user interface object by a user of the terminal, the data being stored in the holding unit;
a displaying unit displaying a second user interface object representing a gift of a second type on the display while the video data is reproduced; and
a download starting unit starting download of data for realizing an effect for the gift represented by the second user interface object upon acceptance of selection of the second user interface object by the user.

10. The terminal of claim 9, wherein an indicator indicating status of the download is displayed in association with the second user interface object on the display.

11. The terminal of claim 9, wherein download of the data for realizing the effect for the gift of the first type is started before the selection of the first user interface object without an instruction from the user.

12. The terminal of claim 11, wherein the starting the download of the data without the instruction from the user includes starting the download of the data for realizing the effect for the gift of the first type specified by referring a list before the selection of the first user interface object without the instruction from the user, and
wherein the list is configured to be updatable.

13. The terminal of claim 9, wherein the download of the data for realizing the effect for the gift of the second type is not started before the second user interface object is selected.

14. The terminal of claim 9, wherein the download of the data for realizing the effect for the gift of the second type has a higher priority than download of the data for realizing the effect for the gift of the first type.

15. The terminal of claim 9, wherein the download starting unit starts download of data for realizing an effect for a gift used by another user of another terminal to which the video data is streamed,
wherein the download of the data for realizing the effect for the gift used by another user has a higher priority than the download of the data for realizing the effect for the gift of the first type, and
wherein the download of the data for realizing the effect for the gift of the second type has a higher priority than the download of the data for realizing the effect for the gift used by another user.

16. The terminal of claim 9, wherein download of data for realizing effects for gifts is started without an instruction from the user, regardless of their gift types, when attributes of the user meet a predetermined criterion.

17. A method performed in a terminal, comprising:
displaying a first user interface object representing a gift of a first type on a display while video data related to a live-stream is reproduced;
processing data for realizing an effect for the gift represented by the first user interface object upon acceptance of selection of the first user interface object by a user of the terminal, the data being stored in a holding unit of the terminal;
displaying a second user interface object representing a gift of a second type on the display while the video data is reproduced; and
starting download of data for realizing an effect for the gift represented by the second user interface object upon acceptance of selection of the second user interface object by the user.
